(19) United States
(12) Patent Application Publication
(10) Pub. No.: US 2018/0133730 A1
(43) Pub. Date: May 17, 2018

(54) SYSTEM AND METHOD FOR MONITORING PAINT THICKNESS IN PAVEMENT MARKING APPLICATIONS

(71) Applicant: EPIC Solutions, Inc., Fargo, ND (US)

(72) Inventors: Jeffrey Arnold Wilkens, West Fargo, ND (US); Timothy John Marthe, Relies Acres, ND (US)

(73) Assignee: EPIC Solutions, Inc., Fargo, ND (US)

(21) Appl. No.: 15/811,176

(22) Filed: Nov. 13, 2017

Related U.S. Application Data
(60) Provisional application No. 62/421,457, filed on Nov. 14, 2016.

(51) Int. Cl. B05B 9/06; E01C 23/22

(52) U.S. Cl. CPC B05B 9/06; E01C 23/222

(57) ABSTRACT

Presented herein are a system and method (i.e., utilities) for monitoring the flow of materials used to mark road surfaces and other surfaces. The utilities utilize one or more flow meters to monitor individual flow rates of individual spray guns and may also utilize one or more pressure sensors to monitor and control individual flow rates.

### RELATED APPLICATIONS

This application claims the benefit of U.S. Provisional Patent Application No. 62/421,457 filed Nov. 14, 2016, entitled “SYSTEM AND METHOD FOR MONITORING PAINT THICKNESS IN PAVEMENT MARKING APPLICATIONS,” which is incorporated herein by reference in its entirety.

### FIELD

The present invention relates to pavement marking. More particularly, the invention relates to monitoring the thickness of pavement marking materials applied to a roadway, runway, parking lot, or any other type of surface (collectively, “roadway”) by a moving vehicle.

### BACKGROUND

It is well known that roadways, runways, and other types of surfaces need to have lines or intermittent stripes painted on them to guide traffic, airplanes, etc. A pavement marking material such as, for example, conventional paint, epoxy, MMA, or thermoplastic (referred to herein generally as “paint” or “marking material”) is used to create visible stripe paint line. Glass beads may be applied to the freshly painted surface immediately after the pavement marking material is applied. The glass beads serve to make the stripes or lines more visible because they reflect light, such as from a vehicle's headlights.

Typically, a flatbed truck is configured to carry all the necessary supplies and equipment so that pavement marking material and beads can be applied to the road surface in an economical fashion. A truck used to apply beads and pavement marking materials, referred to herein as a paint truck, has one or more pavement marking material tanks and one or more bead tanks. The bead tank(s) is/are usually large enough to hold sufficient beads for the application to the pavement marking materials in the paint tanks. In some embodiments, different bead tanks may include different types of beads. In operation, paint trucks may travel as fast as 25 mph while painting continuous or intermittent paint lines on the road surface. Though discussed primarily in relation to a paint truck, it will be appreciated that similar systems are incorporated into walk behind units and small ride-on units.

Various different application systems are utilized to apply paint and can vary based on the type of paint being applied. For instance, “airless” and “atomized air” are the “systems” commonly used to apply paint. In an airless system, the paint is delivered to a high pressure pump, usually a piston pump, which pumps the paint through a small nozzle on the end of a spray gun without mixing air with the paint, and thereby creates the paint line on the roadway. In an atomized air pressure pot system, the paint storage tank (also referred to as a “paint pot” or “pressure pot”) is pressurized up to approximately 120 lbs. of pressure. This pressure forces the paint from the tank and out through the spray gun. In the spray gun of an atomized air system, air is mixed with the paint at the nozzle and creates the paint line on the roadway. A pressure pot system does not utilize a pump to move the paint like the airless system.

For thermoplastic paints, “spray,” “extrusion,” and “ribbon gun” systems may be used for paint application. In these systems the thermoplastic starts out in a solid form, which is heated past its melting point using a furnace mounted on the truck. In alternate arrangements, a separate pumper truck may provide pre-melted materials to a tank of the paint truck. Once the thermoplastic is a liquid material (i.e., melt), the thermoplastic melt is ready for application to a surface. In a spray system, the thermoplastic melt is pumped using a high pressure pump, which pushes the material through a small opening/orifice at the spray gun. This creates a line on the roadway. In the extrusion system, the thermoplastic melt is pumped at a lower pressure and gathers in a collection box disposed by the road surface. The box opens when material is desired and small, flat stream of material is placed on the ground as the vehicle moves forward. The ribbon gun method is similar to extrusion system with the exception of the box used to gather material by the road surface. A ribbon gun places material directly on the roadway after passing through a flat opening as wide as the desired line.

Beads are generally applied using a “pressure pot” system where pressure applied to the holding tank of the beads forces the beads through subsequent connecting lines to an application gun. Glass beads are placed on the paint after the spray gun to help with reflection of the line. Regardless which paint and bead system or combination of systems is used, the equipment for such systems is typically mounted on a flatbed truck.

In any application system, there is usually a specific amount of paint and beads that one is required to apply per foot to meet various specifications (e.g., state highway requirements). For example, such a specification may require that a 300 lineal feet of a 4 inch wide paint line utilize a gallon of paint and 6 lbs. of beads. Stated otherwise, the paint line has a required ‘mil thickness’. Accordingly, it is desirable to monitor the amount of material applied in order to comply with mil thickness specifications and/or to avoid over application (e.g., waste) of such materials.

Further, because there are many opportunities for unscrupulous contractors to cheat (for example, if a contractor has not been applying enough paint or beads figures this out at the end of the day when he has more paint left in his tank than he should, he has an incentive to dump the extra paint or apply extra paint at the end of the day so that when the state Department of Transportation (“DOT”) official checks how much paint was used it appears that the amount the specification called for was used), it would be highly beneficial if a device or method existed so that a contractor could more closely monitor the amount of paint being applied. In addition to the obvious benefits to the contractor of actually knowing the quantities of materials being used, he could provide a written record of this information to the DOT or whatever other agency specified the job to prove compliance with the specification.

Previous methods of monitoring mil thickness and paint/bead usage have included stroke counting, paint tank flow meters and paint tank weight. A stroke counter is an on/off sensor that counts each time a pump that is supplying material to the spray guns strokes up and down. The volume for each pump stroke is determined by the pump manufacturer and verified by a calibration procedure. This is a common method to determine the volume of paint applied as it is the simplest and cheapest to install. The main disadvantage is the strokes can be altered and cheating is possible. Another issue is most states only allow stroke counters on positive displacement pumps. On other types of pumps, like diaphragm pumps, the volume per stroke can change by type of material or air in the line or when a tank gets low.

Flow meter monitoring currently utilizes a flow meter installed on the output line near the bottom of the paint tank. In such an arrangement, the output line (e.g., a 2 inch line) exits the tank, proceeds through the flow meter, through a manifold and to multiple spray guns on either side of the truck. The flow from the paint tank is divided by all the spray guns being fed by that tank. The flow meters are calibrated from the manufacture and verified by a calibration procedure. Benefit of this method is hills; rough road, etc. do not affect the readings. Disadvantage is on skips or short segments of lines the accuracy is off due to low flow. The flow meter is calibrated for a range of flow as example 1.3 to 80 Gallons Per Minute (GPM).

A weight based system mounts a load cell(s) under each tank and measures the weight of the tank and the material therein (e.g., paint). The volume of material used is determined from a starting weight and then an ending weight. That weight is divided by the weight of paint per gallon (e.g., lbs/gl) to determine total volume of material applied. One benefit of this method is that, as the weight applied is known, an operator is unable to alter application data. A disadvantage with a weight system is that sudden stops, hills and rough roads can cause the material in the tanks to move such that the weight fluctuates. This requires stopping the truck and letting the materials in the tank(s) settle to get an accurate reading.

The volume of paint applied by a spray gun can change due to a number of different factors. For instance, paint systems typically utilize a number of filters between the spray gun(s) and the tanks. If the filters accumulate contaminates, the volume of paint supplied to the spray guns can change. Along these lines, being able to more accurately monitor the amount of paint and/or beads being applied allows the contractor to immediately make adjustments to compensate for such conditions rather than his finding out that he has been applying to little paint to meet specifications for a portion of entirety of a job.

### SUMMARY

The present invention allows the real time or near-real time monitoring of paint usage and corresponding line thickness. The disclosed systems and methods (i.e., utilities) allow for monitoring paint usage by continually measuring the flow of individual spray guns in conjunction with distance traveled (e.g., vehicle speed).

In one aspect the utility monitors the amount of material being applied to a surface. The utility includes flow meters located each individual supply line of each individual spray gun. These flow meters generate output signals representative of the volume of paint passing through an individual spray gun. The utility utilizes a microprocessor that is programmed to receive the output signals from the individual spray gun flow meters to calculate the thickness of material being applied to a surface by each spray gun. Typically, the processor also receives a travel speed for use in calculating the line thickness. Further, each individual supply line may further include a controllable valve (e.g., ball valve) that allows for individually altering the volume of paint passing through each spray gun. In one arrangement, the system allows for real-time monitoring and adjustment of the individual valves to ensure the paint supplied by two spray guns has a common mil thickness. In a further arrangement, additional inputs from additional sensors may be utilized to calculate mil thickness.

A second aspect provides a device for applying a pavement marking material and, optionally beads, to a roadway. The device includes a first tank for the pavement marking material, and at least two spray guns operative to simultaneously apply paint to a roadway surface. Flow meters attached to supply lines connecting each spray gun to a common paint manifold output electronic signals representative of the flow volume passing through each spray gun. Additionally, pressure sensors may be disposed in the main paint supply line, within the manifold, and/or along each individual spray gun supply line to aid in monitoring and controlling outlet pressures. A monitoring device provides an electronic signal indicative of vehicle speed over a roadway. The device also includes a microprocessor programmed to receive the electronic signals from the flow meters and/or pressure sensors and output at least one of the following: the total amount of pavement marking material being applied to the roadway by each spray gun and/or the thickness of pavement marking material applied by each spray gun to the roadway. In one arrangement, the output from the processor is displayed on a user display. Such user displays may include without limitation, laptop computers and/or dedicated user displays. In another arrangement, a controller is provided that allows operating valves associated with each spray gun to, for example, equalize the volume and/or thickness of paint lines applied by each spray gun. In this arrangement, a user may control the valves or the valves may be automatically controlled.

The above noted aspects may be incorporated with various application systems including airless and atomized air systems as well as thermoplastic systems including spray, extrusion and ribbon gun systems.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

For a more complete understanding of the present disclosure and further advantages thereof, reference is now made to the following detailed description taken in conjunction with the drawings in which:

FIG. 1 illustrates one embodiment of a line painting truck.

FIG. 2 illustrates a user interface disposed within the cab of the line painting truck.

FIG. 3 illustrates a schematic representation of a system of the invention.

### DETAILED DESCRIPTION

Reference will now be made to the accompanying drawings, which at least assist in illustrating the various pertinent features of the presented inventions. The following description is presented for purposes of illustration and description. Furthermore, the description is not intended to limit the disclosed embodiments of the inventions to the forms disclosed herein. Consequently, variations and modifications commensurate with the following teachings, and skill and knowledge of the relevant art, are within the scope of the presented inventions.

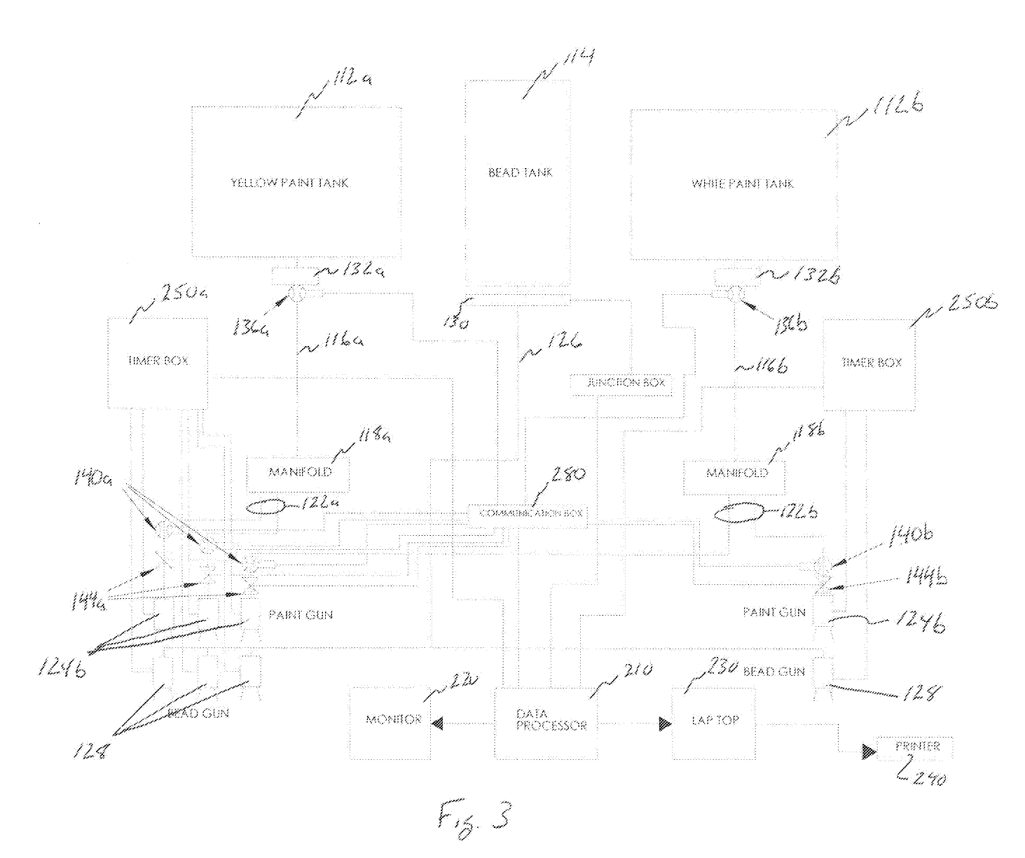

Referring to FIG. 1, an embodiment of the invention is shown that includes at least one generally cylindrical paint tank 112 and a bead tank 114 that are disposed on a paint truck 10. As schematically illustrated in FIG. 3, the paint tank 112 and bead tank 114 are interconnected to one or more spray guns 124 and bead guns 128 by paint supply lines 116, 122 and bead supply lines 126, respectively, as schematically illustrated in FIG.3. Though shown on a paint truck, it will be appreciated that the system(s) disclosed herein have broader application and may be utilized on walk behind painting units as well as ride-on units (collectively, “paint application vehicles”). The discussion relating to a paint truck is for purposes of discussion and not by way of limitation.

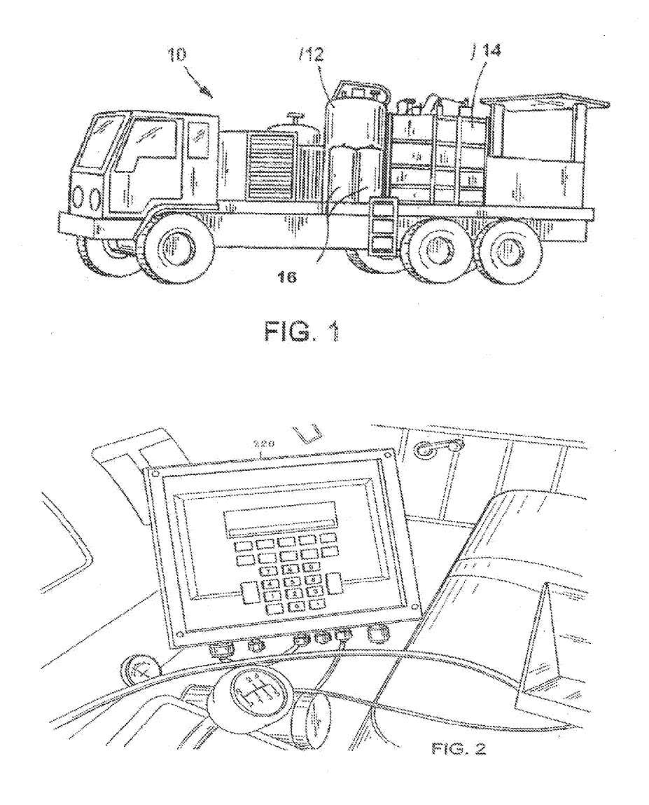

FIG. 2 depicts a user interface/monitor 220 mounted on a paint application vehicle such as in the cab of a truck. The user interface 220 is programmable and includes a microprocessor that may be instructed to monitor, collect, display and control a variety of desired information. In alternate arrangements, the user interface may be a laptop computer operatively connected to the system. What is important is that the system includes a processor that is operative to receive and process signals from system components and provides a user interface to receive user input.

In the non-limiting embodiment schematically illustrated in FIG. 3, the system includes two paint tanks 112 (e.g., a yellow paint tank 112a and a white paint tank 112b) and one bead tank 114. The bead tank is weighed by one or more weigh bars 130 that allow for monitoring bead usage from the tank. A weigh bar is a device that is fixed at one end and flexes under an applied load. Strain gauges on the bar transform this physical change into voltage values. A suitable weigh bar for use in the invention is available from Weigh-Tronic, Inc., Fairmont, Minn. However, a variety of other weight-measurement devices may be used to provide an accurate measurement of the weight of the tank. The use of a weigh bar to monitor usage of beads and, in some instances, paint is set forth in U.S. Pat. No. 6,439,473, the entire contents of which is incorporated by reference herein. In some embodiments, the paint tanks 112 may also be mounted on weigh bars.

In operation, paint flows out from the paint tanks 112a, 112b (hereafter duplicate elements such as 112a, 112b are, after introduction, referred to in singular “112” unless expressly referenced), where pumps 132a, 132b pressurize flow and supply the paint from their respective tanks through flow meters 136a, 136b to main supply lines 116a, 116b and into collection manifolds 118a, 118b. The paint then flows from the manifolds 118 through one or more secondary supply lines 122a, 122b to various spray guns 124a, 124b where the paint is applied to the road surface. The number of secondary supply lines 122 and number of spray guns 124 may be varied depending on the exact configuration of a painting system. However, each manifold 118 will typically connect to at least two spray guns 124 (e.g., one or more on either side of the vehicle). Beads flow out of the bead tank 114 through a supply line 126 to a series of bead guns 128, where the beads are applied to paint applied to a road surface by the spray guns 124. Typically, the number of bead guns 128 match the number of spray guns 124. In an alternate embodiment (not shown), the paint moves from the supply tanks through the main supply lines 116 under the force of gravity or pot pressurization. That is, in an alternate embodiment the system does not utilize a pump to move the material but rather relies on head pressure (e.g., pressure pot system). The system disclosed herein is functional with both pump operated and gravity fed/pressure pot systems.

One or more pressure sensors may be used to monitor the pressure of the paint lines as paint is applied. These pressure sensors 160, 162, 164 (only one set shown for clarity) may be disposed on or within the main paint supply lines 116, the manifolds 118, the secondary paint supply lines 122, etc. In this regard, pressure levels may be monitored throughout the system to identify shifts in pressure corresponding to controllable events. For example, when a first spray gun paints a dashed line, pressure levels within various parts of the system may spike and drop in conjunction with closing and opening of the spray gun valve. This may have the unintended consequence of increasing and decreasing the pressure at a second spray gun. In a scenario in which the second spray gun is painting a solid line (thereby retaining the spray gun valve of the second spray gun open), for example, the pressure changes may increase and decrease the thickness of the painted line by affecting the volume of paint being pushed through the stationary valve.

By monitoring the effects of certain actions or operating conditions on pressure levels throughout the system, corrective action can be taken to maintain even flow volumes at the spray guns. For example, a valve (e.g., ball valve) controlling the flow to the second spray gun can be opened slightly each time the valve controlling the flow to the first spray gun is opened and closed slightly each time the valve controlling the flow to the first spray gun is closed. In this regard, when the pressure in the system drops due to spraying from the first spray gun, the second spray gun, which is continuously spraying, may open wider to account for the drop in pressure. In this regard, the flow rate of paint from the second spray gun may be maintained.

In various embodiments, the temperature of the material may also be monitored by one or more temperature probes (not shown). Information from such sensors may be used for calibration purposes. However, it will be appreciated in some embodiments, information relating to pressure and/or temperature may be known or inferred and use of such sensors may not be necessary. Likewise, one or more optional pump sensors may monitor pump operation (e.g., rpm). Signals from such sensors, if utilized, are transmitted back to a data/communication box 280. Alternately, such signals may be provided directly to a processor 210, which may be incorporated into the monitor 220 and/or a separate computer/laptop 230.

Timer boxes 250a, 250b may be configured to open and close the spray and bead guns, for example, to generate proper spacing between and length of skips or dashed lines. Signals identifying the opening and closing of the spray guns are transmitted to the communication box 280. The communication box 280 can consist of a PLC or microprocessor and typically incorporates computer readable storage media (not shown). In the illustrated embodiment, the communication box 280 transmits signals back to the data processor 210. The processor 210 may be programmed with instructions to cause it to display data on a peripheral device such as a monitor 220 in the cab of the truck, if the system is installed on a truck, or the screen of a laptop computer 230 or mobile device. The laptop computer 230 can then print data to a printer 240 to generate a written report that contains the data.

Signals from the main line flow meters 136, a vehicle speed from a vehicle speed sensor (not shown) and the timer box 250, as well as signals from any or all of temperature sensors, the pressure sensors, pump sensors, and/or vehicle speed from a vehicle speed sensor (not shown) may be input to the data processor 210. That is, sensor outputs are input to the communication box 280 and/or processor 210, which may either comprise a Programmable Logic Controller (PLC) or programmable circuit board. In its simplest form, the PLC utilizes this information to determine how much material (volume and/or weight) is being applied to the road surface. That is, when the volume of paint passing through the main supply line, line width and vehicle speed are known, the thickness (e.g., mil thickness) of the line on the spray surface can be calculated based on known characteristics of the spray gun(s) applying paint.

In order to calculate the volume of fluid flow through a particular spray gun 124 and the resulting mil thickness of a paint line, the processor must have access to various data. Specifically, the size of the supply lines and/or the orifice size of the spray gun may be used to effectively calculate flow volume through the spray gun(s) applying paint. That is, flow volumes of the individual spray guns are dependent at least upon the size of the orifice in the spray gun and/or type of spray gun and different calibration values may be indexed against different spray gun sizes and/or types. Often, such data is incorporated in look-up tables or calibration curves/equations that allow for determining mil thickness that is based on one or more variables (e.g., vehicle speed, main line flow volume etc.). Such information may be stored to computer readable storage media. The storage of different calibration information allows user to input necessary information prior to beginning application. Such information may include, without limitation, gun type, gun size, material type and/or temperature.

While providing a means for estimating mil thickness, this methodology has some limitations. For instance, the present inventor has recognized that main line flow meters, currently installed on the main supply lines, often operate outside of their accurate calibration ranges. That is, the main supply line is normally a large diameter line (e.g., 2″ line) which passes through a manifold to supply secondary lines connected to multiple spray guns (e.g., on either side of the truck). When multiple spray guns are concurrently applying paint, the flow is divided by all the spray guns being used and accurate information about how much paint passes through each spray gun is unknown. Rather, it is assumed based on the orifice size of the spray gun. Further, the main line flow meters are calibrated by their manufacturers. However, for large diameter flow meters incorporated into large diameter supply lines, the calibrated flow rate is typically between, for example, 1.3 to 80 Gallons Per Minute (GPM). In low flow applications, such as skips or short segments of lines, the accuracy of such large diameter flow meter is off due to low flow. That is, when striping skips, the flow could be 1 gallon per minute where the flow meter is outside its calibrated range. Accordingly, this affects the accuracy of the calculated mil thickness.

Additional limitations affecting the accuracy of previous mil thickness calculations, recognized by the inventor, include differing flow rates when multiple spray guns are utilized. That is, when paint is sprayed through two identical spray guns, the actual volume of paint sprayed by each spray gun may differ. That is, even on a new truck with new lines and spray guns the flow rate can and will be different on each spray gun. Factors that prevent the mil thickness applied by each spray gun from being the same include line pressure and how the plumbing to each spray gun is completed. For instance, if a secondary supply line of one spray gun is longer or includes more turns/bends than a secondary supply line of a second spray gun, the flow volume out of these spray guns is typically different. Further, the orifice tips of the spray guns may wear at different rates and/or be replaced at different times. If the orifice tips wear differently or are replaced at different times, one spray gun will typically spray more paint than the other spray gun.

The problem of one spray gun spraying more than another results in significant problems. For instance, when an operator is painting a double yellow center line for a no passing zone, a system using a main line flow meter volume to determine mil thickness may calculate a 15 mil thickness for each line based on the total volume of paint used. However, the system does not know if the mil thickness is the same on both lines. By way of example, the mil thickness on one line could be 13 mil while the other line is 17 mil on the other. In such a situation the 13 mil line will wear off faster than the other line potentially resulting in a safety hazard (e.g., missing one of the no passing lines) and/or the need to prematurely repaint the lines. Further, inaccuracies between lines can result in additional issues. For instance, glass beads applied to lines of different thicknesses reflect differently. The 13 mil line will be brighter at first but then as time and wear on the line the beads will come out and then the line is dull and not reflective and the 17 mil line will not be as reflective because the beads will sink if the line is too thick. These are just a couple examples of problems that result from differing line thicknesses.

To alleviate these and additional concerns, the present disclosure incorporates the use of individual spray gun flow meters as illustrated in FIG. 3. As shown, each secondary line 122 incorporates an individual flow meter 140a, 140b (secondary line flow meter) proximate to each individual spray gun 124. These flow meters 140 are disposed in the flow path of the smaller diameter secondary flow lines 122. Accordingly, these flow meters 140 have calibration ranges that are accurate for flow levels that are significantly lower than the main line flow meters 136. The flow meters 140 are calibrated to the flow of the individual spray guns and are in a much tighter range (0.06 GPM to 6 GPM). Typically, to provide improved flow readings, it is desirable to incorporate the flow meters 140 into the secondary supply lines 122 at a location as close as possible to the spray guns 124 and/or with as few bends between the meter and the spray gun. The incorporation of the individual flow meters 140 allows for improved monitoring of the individual flow of each spray gun 124. Along these lines, electronic flow outputs of each flow meter 140 are output to the communication box 280 and/or the data processor 210. This allows outputting real-time individual spray gun flow rates to a user via the monitor 220 and/or laptop 230 and/or automated flow control.

To provide further control of the system, a controllable valve 144a, 144b may be incorporated into each secondary supply line 122. As shown, the valves 144 are disposed between the spray guns 124 and the flow meters 140. The valves 144 may be manually adjustable or automated. In the latter regard, the valves 144 may be electronically connected to to the communication box 280 and/or the data processor 210. This allows adjusting each valve 144 to balance the volumetric output of each spray gun 124. Alternatively, the data processor 210 may automatically adjust the valves 144 to achieve substantially equal output volumes. In this regard, the processor 210 may utilize data from the flow meters in the secondary supply lines 140 and/or data from pressure sensors 164 in the secondary flow lines to adjust the flow though the guns 124 to provide an equalized flow. In further arrangements, the processor may utilize data from a flow meter 136 into a manifold 118 in conjunction with the total flow out of the manifold to fine tune the control of the vales 144 to equalize flow. Additionally or alternatively, the processor may utilize outputs form the pressure sensor 160 of the main flow line 116 and/or the pressure sensor 162 of the manifold to equalize flow. In any case, the valves 144 (e.g., ball valves) work to throttle the flow of paint through the spray guns 124. In a further arrangement, a user or the data processor 210 may utilize the flow information from the spray gun flow meters 140 in conjunction with the control of the valves 144 to ensure that both (or more) spray guns 144 are spraying substantially equal volumes and to confirm that the total applied volume corresponds to a desired application volume/thickness.

Typically, the PLC is programmed to take the input information and formulate data to be displayed to the operator. The data includes but is not limited to current material flow rate, accumulated gallons or pounds used and applied thickness, which may be displayed on a per spray gun basis. The information is displayed on a device such as a laptop 230 via graphical user interface (GUI). The GUI allows the user to interact with the PLC to track the various outputs. The data is stored electronically for future reference or to be printed out in a report by a printer.

In one embodiment, the information from the processor may be displayed on a display device (e.g., monitor 220 or laptop 230) disposed in the cab of the paint truck proximate to the operator. This allows the operator to continuously monitor paint and/or bead usage and/or applied thickness and to provide a permanent record of the activities for a particular vehicle over a specified time period.

The foregoing description of the presented inventions has been presented for purposes of illustration and description. Furthermore, the description is not intended to limit the inventions to the forms disclosed herein. Consequently, variations and modifications commensurate with the above teachings, and skill and knowledge of the relevant art, are within the scope of the presented inventions. The embodiments described hereinabove are further intended to explain best modes known of practicing the inventions and to enable others skilled in the art to utilize the inventions in such, or other embodiments and with various modifications required by the particular application(s) or use(s) of the presented inventions. It is intended that the appended claims be construed to include alternative embodiments to the extent permitted by the prior art.

What is claimed:

1. A method for controlling a thickness of a marking being applied to a surface by a marking application vehicle, comprising:
receiving, at a processing engine, a first electronic signal from a first flow meter representative of a first flow volume of marking material passing through a first controllable valve disposed along a first supply line associated with a first spray gun;
receiving, at the processing engine, a second electronic signal from a second flow meter representative of a second flow volume of marking material passing through a second controllable valve disposed along a second supply line associated with a second spray gun;
comparing said first and second electronic signals to identify a difference between said first and second flow volumes; and
generating a first control signal for receipt by one of the first and second controllable valves, wherein said first control signal operates the one of the first and second controllable valves to substantially equalize said first flow volume and said second flow volume.

2. The method of claim 1, further comprising:
receiving, at the processing engine, a third electronic signal representative of a speed of the marking application vehicle over the surface;
calculating a first mil thickness of the marking material applied by said first spray gun;
calculating a second mil thickness of the marking material applied by said second spray gun; and
generating an output indicative of said first and second mil thicknesses.

3. The method of claim 2, wherein the calculating the first and second mil thicknesses comprises:
accessing calibration data from a computer readable storage medium, wherein said calibration data includes at least one of:
an orifice size of at least one of said first and second spray guns;
an orifice orientation associated with at least one of said first and second spray guns;
standard information associated with a known type of spray gun, wherein at least one of the first and second spray guns comprises the known type; and
a distance between the surface and a portion of at least one of the first and second spray guns.

4. The method of claim 3, wherein said calibration data comprises a look-up table or curve generated using empirical data.

5. The method of claim 1, further comprising:
receiving, at the processing engine, a third electronic signal from a first pressure sensor representative of a first pressure within the first supply line;
receiving at the processing engine, a fourth electronic signal from a second pressure sensor representative of a second pressure within the second supply line;
monitoring the third and fourth electronic signals in conjunction with timing of transmission of the first control signal to the one of the first and second controllable valves;
determining, based on the monitoring, a pressure differential caused by operation of the one of the first and second controllable valves; and
generating a second control signal for receipt by the other of the first and second controllable valves, wherein said second control signal operates the other of the first and second controllable valves to substantially eliminate flow volume fluctuations caused by the pressure differential.

6. The method of claim 1, further comprising:
receiving, at the processing engine, a third electronic signal from a pressure sensor representative of a pressure within a manifold disposed between the first and second supply lines;
monitoring the third electronic signal in conjunction with timing of transmission of the first control signal to the one of the first and second controllable valves;
determining, based on the monitoring, a pressure differential caused by operation of the one of the first and second controllable valves; and
generating a second control signal for receipt by the other of the first and second controllable valves, wherein said second control signal operates the other of the first and second controllable valves to substantially eliminate flow volume fluctuations caused by the pressure differential.

7. A method for controlling a thickness of a marking being applied to a surface by a marking application vehicle, comprising:
receiving, at a processing engine, an electronic signal from a pressure sensor representative of a pressure within a component of a marking system disposed upon the marking application vehicle;
monitoring, at the processing engine, the electronic signal in conjunction with timing of transmission of a control signal to one of a first controllable valve associated with a first supply line corresponding to a first spray gun and a second controllable valve associated with a second supply line corresponding to a second spray gun;
determining, based on the monitoring, a pressure differential caused by operation of the one of the first and second controllable valves; and
generating a second control signal for receipt by the other of the first and second controllable valves, wherein said second control signal operates the other of the first and second controllable valves to substantially eliminate flow volume fluctuations caused by the pressure differential.

8. The method claim 7, wherein the component is one of the first and second supply lines.

9. The method of claim 7, wherein the component is a manifold disposed between the first and second supply lines.

10. The method of claim 7, wherein the component is a main supply line disposed between a marking material supply tank and a manifold, wherein the manifold is disposed between the first and second supply lines.

11. The method of claim 7, wherein the component is one of the first spray gun or the second spray gun.

12. A system for applying a marking material to a surface, comprising:
a first tank for holding a supply of marking material;
a manifold fluidly connected to said first tank by a main supply line;
a first spray gun for applying said marking material to a surface, wherein said first spray gun is connected to said manifold by a first secondary supply line;
a second spray gun for applying said marking material to the surface, wherein said second spray gun is connected to said manifold by a second secondary supply line;
a first flow meter at least partially disposed within said first secondary supply line and operative to generate a first flow signal representative of a first flow rate of marking material passing through said first secondary supply line;
a second flow meter at least partially disposed within said second secondary supply line and operative to generate a second flow signal representative of a second flow rate of marking material passing through said second secondary supply line; and
a processor connected to said first and second flow meters operative to receive said first and second flow signals and generate an output indicative of said first and second flow rates.

13. The system of claim 12, further comprising:
a first valve at least partially disposed within said first secondary supply line; and
a second valve at least partially disposed within said second secondary supply line.

14. The system of claim 13, wherein said first valve and said second valve are adjustable to substantially equalize said first flow rate and said second flow rate.

15. The system of claim 14, wherein said processor is configured to send a control signal to a valve control mechanism configured to adjust at least one of said first and second valves to substantially equalize said first and second flow rates.

16. The system of claim 15, further comprising:
a speed sensor operative to generate a vehicle speed signal associated with a speed of a vehicle supporting said first and second spray guns, wherein said processor utilizes said vehicle speed signal in conjunction with said first and second flow signals to calculate mil thicknesses of markings applied to the surface by said first and second spray guns.

17. The system of claim 13, further comprising:
a pressure sensor operable to generate an electronic signal representative of a pressure within a component of the system;
wherein the processor is operable to receive the electronic signal and monitor fluctuations in the electronic signal caused by operation of the second valve;
wherein the processor is operable to generate a control signal configured to adjust the first valve in response to the fluctuations to maintain a consistent flow rate of marking material through the first secondary supply line.

18. The system of claim 17, wherein the component is one of the first and second secondary supply lines.

19. The system of claim 17, wherein the component is the manifold.

20. The system of claim 17, wherein the component is the main supply line.
